(19) United States
(12) Patent Application Publication
(10) Pub. No.: US 2024/0051219 A1
(43) Pub. Date: Feb. 15, 2024

(54) SYSTEMS AND METHODS OF OFFSET SURFACE DEPOSITION IN ADDITIVE FABRICATION

(71) Applicant: Inkbit, LLC, Medford, MA (US)

(72) Inventors: Wojciech Matusik, Lexington, MA (US); Desai Chen, Arlington, MA (US); Javier Ramos, Brookline, MA (US); Gregory Ellson, Boston, MA (US)

(21) Appl. No.: 17/887,617

(22) Filed: Aug. 15, 2022

(51) Int. Cl. B29C 64/112; B29C 64/209; B29C 64/232; B29C 64/264; B29C 64/336; B29C 64/393; B33Y 10/00; B33Y 30/00; B33Y 50/02; B33Y 70/00

(52) U.S. Cl. CPC B29C 64/112; B29C 64/209; B29C 64/232; B29C 64/264; B29C 64/336; B29C 64/393; B33Y 10/00; B33Y 30/00; B33Y 50/02; B33Y 70/00; B29K 2101/12

(57) ABSTRACT

A method for additive fabrication of an object on a build platform includes depositing material onto a partial fabrication of the object in a number of passes of a printhead over the partial fabrication. The depositing includes repeatedly depositing material onto the partial fabrication in a pass of the printhead over the partial fabrication. The depositing includes depositing a first material onto the partial fabrication at a first height relative to the build platform, and depositing a second material onto the partial fabrication at a second height relative to the build platform, the second height being less than the first height, the depositing of the second material including forming at least one material transition region between the second material at the second height and first material at the second height deposited in a previous pass.

### BACKGROUND OF THE INVENTION

This invention relates to additive fabrication. Inkjet-based additive fabrication systems fabricate objects by repeatedly depositing layers of material from inkjet heads (sometimes referred to as “jets”). Certain types of objects may require deposition of a number of different types of materials from the jets when fabricating a single object. For example, fabrication of a single object may require that the jets deposit build material (e.g., a UV curable resin) and support material (e.g., a wax). The build material forms the object itself and the support material provides structure, for example, to support fabricating of overhanging sections of the object.

In general, materials are emitted from the jets in a liquid state and later solidify or at least partially solidify shortly after being deposited. Solidification of different materials occurs by different processes and at different rates. For example, waxes may solidify by cooling and UV curable resins solidify by polymerization after being exposed to UV light.

### SUMMARY OF THE INVENTION

In some examples, when multiple different materials are jetted in the liquid state and deposited on an object being fabricated, the different materials in their liquid state and flow and mix at a material transition boundary where one material is deposited next to another material, for example, being jetted from different jets during a printing pass forming an added layer on the object. As a result, in some examples, the material transition boundary may not be formed as intended, for example, with mixing causing the boundary to be “smeared” or with flowing causing the boundary to be formed away from its intended position. Such imprecision in the material transition boundaries of layers can result in an imprecisely fabricated object. For example, when the boundary between a support material and a build material is not formed as intended, and the dimensions of the desired object (e.g., after removal of the support material) and/or the surface character (e.g., the smoothness of the surface) may not be as intended.

Aspects described herein improve the precision of object fabrication at material transition boundaries by reducing the flowing and/or mixing of materials at a boundary, thereby forming boundaries more closely to what is intended. One or more approaches form the boundary by causing a first of the two materials at a material transition boundary point to be deposited and sufficiently solidified before depositing the second material at that transition boundary point. Such approaches essentially form what is referred to herein as a “discontinuous surface region” where the surface of the object is intentionally formed to not have a flat top surface after a printing pass, and rather for the surface to have a discontinuity at a material transition boundary (also referred to below as an “offset” surface) allowing adjacent the adjacent material at a boundary point to be deposited in different jetting passes, thereby allowing one of the materials to sufficiently solidify before the other of the materials is deposited. As a result, the two materials at the boundary do not mix or flow at the material transition boundary (or at least such mixing and/or flowing is reduced) because they are not simultaneously in a liquid state at the material transition boundary.

In a general aspect, a method for additive fabrication of an object on a build platform includes depositing material onto a partial fabrication of the object in a number of passes of a printhead over the partial fabrication of the object. The depositing includes repeatedly, determining surface data for the partial fabrication of the object including sensing a surface of the partial fabrication of the object using a non-contact sensor, and depositing, based on the surface data, material onto the partial fabrication of the object in a pass of the printhead over the partial fabrication. The depositing includes depositing a first material onto the partial fabrication of the object at a first height relative to the build platform, and depositing a second material onto the partial fabrication of the object at a second height relative to the build platform, the second height being less than the first height, the depositing of the second material including forming at least one material transition region between the second material at the second height and first material at the second height deposited in a previous pass.

Aspects may include one or more of the following features.

The first material may a phase change material configured to be deposited as a liquid and to solidify as it cools. The first material may be a wax. The first material may be a thermoplastic. The second material may be a curable resin. The second material may be deposited as a liquid and may be curable by exposure to ultraviolet radiation. The first material may have a first rate of solidification, the second material may have a second rate of solidification, and the first rate of solidification may be relatively faster than the second rate of solidification.

The first material at the second height deposited in a previous pass may be substantially solid at the material transition region when the second material may be deposited at the second height. The non-contact sensor may include a laser profilometer. The first material may be dispensed from a first set of one or more nozzles of the printhead and the second material may be dispensed from a second set of one or more nozzles of the printhead. The printhead may be configured for bidirectional deposition of material. The printhead may include a third set of one or more nozzles for dispensing the first material, the second set of one or more nozzles being disposed between the first set of one or more nozzles and the second set of one or more nozzles.

A surface discontinuity may be formed at the material transition region. A layer of material may be deposited onto at least part of the surface of the partial fabrication of the object during each pass. Depositing material onto the partial fabrication of the object based on the surface data may include adjusting an amount of material deposited onto the surface as the printhead moves past the surface based on the surface data. Depositing of the second material may include forming two material transition regions between the second material at the second height and first material at the second height deposited in a previous pass. A well may be formed between the two material transition regions at the second height and the second material flows to fill the well. At least one of the one or more material transition regions may include a tapered surface.

In another general aspect, an apparatus for additive fabrication of an object on a build platform includes a non-contact sensor for determining surface data of a partial fabrication of the object, a printhead configured to deposit material, and a controller configured to control the printhead, the build platform, and the non-contact sensor to deposit material onto the partial fabrication of the object in a number of passes of the printhead over the partial fabrication of the object. The controller is configured to repeatedly determine surface data for the partial fabrication of the object including sensing a surface of the partial fabrication of the object using a non-contact sensor and depositing, based on the surface data, material onto the partial fabrication of the object in a pass of the printhead over the partial fabrication. The depositing includes depositing a first material onto the partial fabrication of the object at a first height relative to the build platform, and depositing a second material onto the partial fabrication of the object at a second height relative to the build platform, the second height being less than the first height, the depositing of the second material including forming at least one material transition region between the second material at the second height and first material at the second height deposited in a previous pass.

In another general aspect, software embodied on a non-transitory, computer readable medium includes instructions for additive fabrication of an object on a build platform. The software includes instructions for causing an additive fabrication system to perform steps of a method comprising depositing material onto a partial fabrication of the object in a number of passes of a printhead over the partial fabrication of the object, the depositing including repeatedly determining surface data for the partial fabrication of the object including sensing a surface of the partial fabrication of the object using a non-contact sensor, depositing, based on the surface data, material onto the partial fabrication of the object in a pass of the printhead over the partial fabrication, the depositing including, depositing a first material onto the partial fabrication of the object at a first height relative to the build platform, and depositing a second material onto the partial fabrication of the object at a second height relative to the build platform, the second height being less than the first height, the depositing of the second material including forming at least one material transition region between the second material at the second height and first material at the second height deposited in a previous pass.

Aspects may have one or more of the following advantages.

Among other advantages, certain materials may be more suitable to precision printing than other materials. Those more suitable materials can be deposited and solidified first, thereby precisely defining transition boundaries between materials. Subsequently deposited materials conform to those boundaries, resulting in a highly precise object.

Aspects described herein are particularly suitable and advantageous for use in a non-contact, machine-vision based printing system where no planarizing of the printed object occurs.

Other features and advantages of the invention are apparent from the following description, and from the claims.

### BRIEF DESCRIPTION OF THE DRAWINGS

FIG. 1 is a schematic drawing of an additive fabrication system.

FIGS. 2-10 are cross-sectional views of an object under fabrication after a first through nineth step of a first illustrative example.

FIGS. 11-19 are cross-sectional views of an object under fabrication after a first through nineth step of a second illustrative example.

### DETAILED DESCRIPTION

1 System Overview

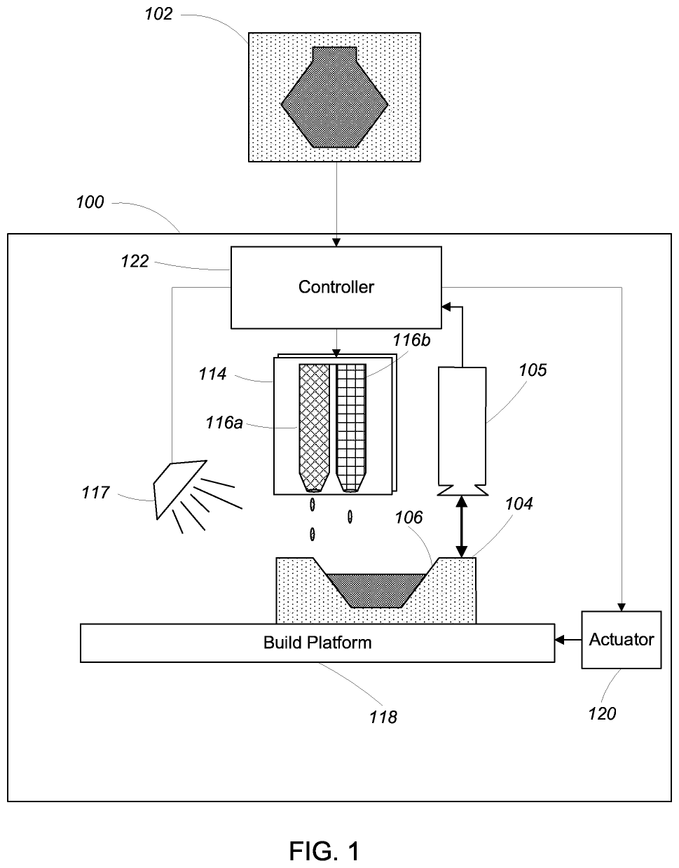

Referring to FIG. 1, an inkjet additive manufacturing system 100 is configured to receive a model object 102 as input and to fabricate a multi-material physical object 104 according to the model object 102. As is described in greater detail below, the system 100 uses an offset surface printing technique to ensure precise fabrication at material transition boundaries 106 of the physical object 104. As used below, an “object” refers to the entire result of the multi-material printing, including the support material that is deposited and that will ultimately be removed to yield the desired object (also referred to as the “part” being fabricated).

The system 100 includes a build platform 118, printheads 114 including jets 116a-b, a UV lamp 117, a sensor 105 (e.g., a laser profilometer), and a controller 122. The build platform 118 is controllable by the controller 122 (e.g., using an actuator 120) to move in three degrees-of-freedom (i.e., along an x-axis, a y-axis, and a z-axis) relative to the printheads 114. The printheads 114 are controllable to emit material from the individual jets 116a-b. In some examples, the jets 116a-b include a first jet 116a that emits build material (e.g., a UV curable build material) and a second jet 116b that emits support material (e.g., a wax). The UV lamp 117 exposes the emitted build material to ultraviolet light, causing the build material to polymerize.

The sensor 105 is positioned relative to (e.g., above) the partially fabricated physical object 104 and is used to determine physical characteristics of the partially fabricated object. For example, the sensor 105 measures one or more of the surface geometry (e.g., a depth map characterizing the thickness/depth of the partially fabricated object) and subsurface characteristics (e.g., in the near surface comprising, for example, 10 s or 100 s of deposited layers). The characteristics that may be sensed can include one or more of a material density, material identification, and a curing state. Very generally, the measurements from the sensor 105 are associated with a three-dimensional (i.e., x, y, z) coordinate system where the x and y axes are treated as spatial axes in the plane of the build surface and the z axis is a height axis (i.e., growing as the object is fabricated).

In some examples, in the context of a digital feedback loop for additive fabrication, the additive manufacturing system deposits layers of material and the sensor 105 captures measurement data characterizing the surface of the object 104. For example, the sensor 105 scans the partial object (or empty build platform), then the system prints a layer (or layers) of material(s) based on the measurement data. The sensor 105 then scans the (partially built) object again. The new depth sensed by the sensor 105 should be at a distance that is approximately the old depth minus the thickness of layer (this assumes that the sensor 105 is positioned on the top of the of the object being built and the object is being built from the bottom layer to the top layer and the distance between the sensor 105 and the build platform is unchanged). Various types of sensing such as optical coherence tomography (OCT) or laser profilometry can be used to determine depth and volumetric information related to the object being fabricated.

When the system 100 fabricates the physical object 104, the controller 122 uses the model object 102 to coordinate movement of the build platform 118 relative to the jets 116a-b with emission of material from the jets 116a-b, causing deposition of specified materials in specified x, y, z locations according to non-contact feedback of the object characteristics determined using the sensor 105. Examples of printing systems that can incorporate the techniques described herein can be found in U.S. Pat. No. 10,252,466, “Systems and Methods of Machine Vision Assisted Additive Fabrication,” U.S. Pat. No. 10,456,984, “Adaptive Material Deposition for Additive Manufacturing,” and U.S. Pat. No. 11,173,667, “Precision System for Additive Fabrication,” which are each incorporated by reference herein.

### 2 Example 1

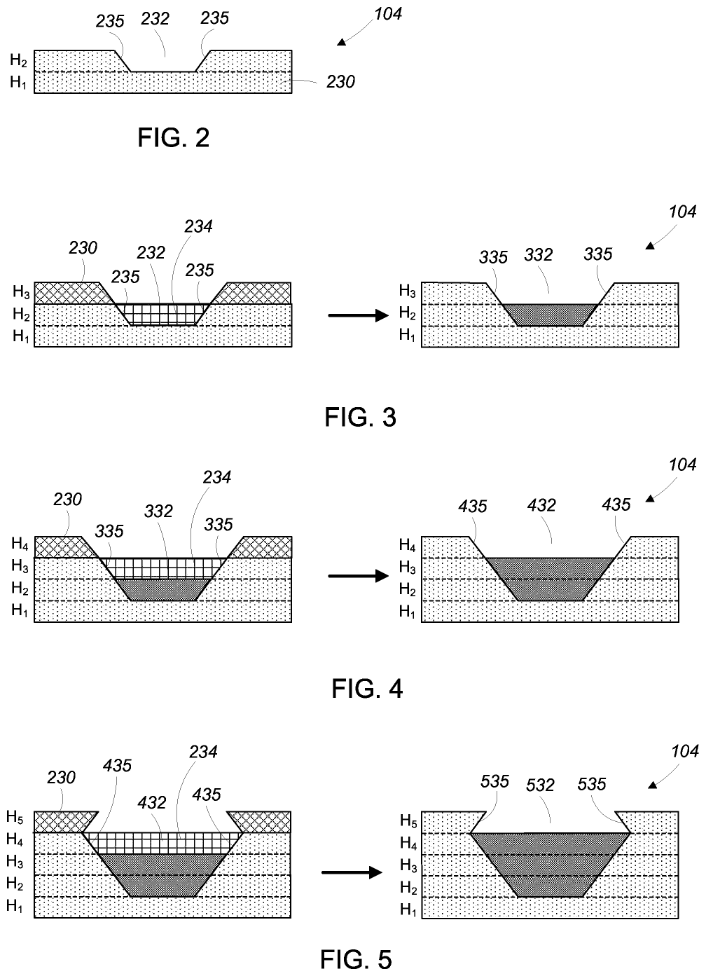

In the example shown in FIGS. 2-10, an offset printing technique is described, in which deposition of a first material (e.g., the wax material) “leads” deposition of a second material (e.g., the UV curable build material) both in time and height, as measured from the build platform 118. In some examples, the first material is deposited and solidifies to form a well into which the second material is deposited. The well causes the surface of the partially fabricated object to be substantially “discontinuous” during fabrication. When the second material is deposited as a liquid, it is contained in and assumes a shape of the well and is subsequently solidified (e.g., by curing). The prior solidification of the first material ensures that material flow and mixing at a material transition boundary between the two materials is minimized while the second material is in a liquid state in the well. The example uses two-dimensional, cross-sectional view of the object as it is being fabricated for illustrative purposes, but it should be noted that the object is fabricated in three-dimensions and that the layers of materials and “wells” described below are three-dimensional.

Referring to FIG. 2, a partially fabricated object 104 includes two previously deposited layers of wax material 230 at heights H₁ and H₂. The wax material deposited at heights H₁ and H₂ defines a well 232 where UV curable build material (e.g., a UV curable resin) is to be deposited. However, deposition of the wax material 230 “leads” deposition of the build material in this example. As such the wax material at heights H₁ and H₂ is deposited and has solidified in FIG. 2. The surfaces of the wax material 230 that define the well 232 are the material transition boundary 235. Note that in this example, the wax material 230 at the material transition boundary 235 at height H₁ forms a sloped surface. This type of a sloped surface can be deposited by the printheads 114 by, for example, adjusting an amount of ejected material or by a dithering operation.

Referring to FIG. 3, in a next pass of the partially fabricated object 104 under the printheads 114 (not shown), another partial layer of wax material 230 is deposited at height H₃ and a partial layer of UV curable material 234 is deposited at height H₂, filling the well 232 with UV curable material. The wax material at height H₃ solidifies (e.g., by cooling) and solidification of the UV curable material 234 is initiated by exposure to UV radiation. A new well 332 with a new material transition boundary 335 is defined by the wax material at height H₃ and the UV curable material at height H₂.

Referring to FIG. 4, in a next pass of the partially fabricated object 104 under the printheads 114 (not shown), another partial layer of wax material 230 is deposited at height H₄ and another partial layer of UV curable material 234 is deposited at height H₃, filling the well 332 with UV curable material. The wax material at height H₄ solidifies and solidification of the UV curable material 234 is initiated by exposure to UV radiation. A new well 432 with a new material transition boundary 435 is defined by the wax material at height H₄ and the UV curable material at height H₃.

In the examples of FIGS. 3 and 4, the sloped surfaces 235 and 335 both slope away from a center of the wells 232 and 332, respectively. In such a configuration, deposition of the UV curable material in the wells 232 and 332 and the next layer of wax material can be performed in different orders. That is, the wells 232 and 332 can be filled with UV curable material prior to deposition of the next layer of wax material, after deposition of the next layer of wax material, or at the same time as deposition of the next layer of wax material. In the examples of FIGS. 5-7, the sloped surfaces 535, 635, and 735 all slope toward the center of the wells 532, 632, and 732. In such a configuration, it may be preferable to deposit the UV curable material in the wells 532, 632, and 732 in advance of depositing the subsequent layers of wax material to prevent deposited wax material from overhanging and interfering with deposition of the UV curable material. For example, the UV curable material is deposited in the well 532, then the subsequent wax later is deposited to form the well 632, which is filled with UV curable material, and so on.

Referring now to FIG. 5, in a next pass of the partially fabricated object 104 under the printheads 114 (not shown), another partial layer of UV curable material 234 is deposited at height H₄, filling the well 432 with UV curable material and then solidification of the UV curable material 234 is initiated by exposure to UV radiation. Then another partial layer of wax material 230 is deposited at height H₅ and solidifies to form a new well 532 with a new material transition boundary 535 defined by the wax material at height H₅ and the UV curable material at height H₄. Note that the partial layer of wax material forming the material transition boundary 535 at height H₅ includes a portion that overhangs the UV curable material deposited at height H₄. This is yet another type of sloped surface that can be deposited by the printheads 114 by, for example, adjusting an amount of ejected material or by a dithering operation.

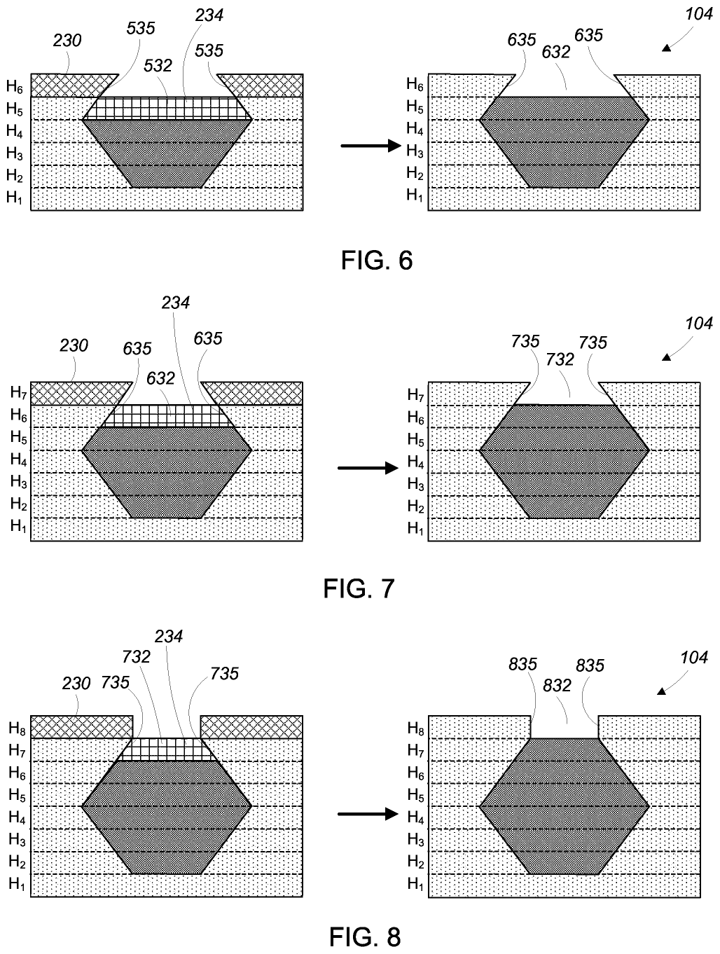

Referring to FIG. 6, in a next pass of the partially fabricated object 104 under the printheads 114 (not shown), another partial layer of UV curable material 234 is deposited at height H₅, filling the well 532 with UV curable material. The UV curable material 234 flows in the well 532 to fill the area of the well beneath the overhanging portion of the wax material at height H₅ and solidification of the UV curable material 234 is initiated by exposure to UV radiation. Then another partial layer of wax material 230 is deposited at height H₆ and solidifies to form a new well 632 with a new material transition boundary 635 defined by the wax material at height H₆ and the UV curable material at height H₅.

Referring to FIG. 7, in a next pass of the partially fabricated object 104 under the printheads 114 (not shown), another partial layer of UV curable material 234 is deposited at height H₆, filling the well 632 with UV curable material. The UV curable material 234 flows in the well 632 to fill the area of the well beneath the overhanging portion of the wax material at height H₆ and solidification of the UV curable material 234 is initiated by exposure to UV radiation. Then another partial layer of wax material 230 is deposited at height H₇ and solidifies to form a new well 732 with a new material transition boundary 735 is defined by the wax material at height H₇ and the UV curable material at height H₆.

Referring to FIG. 8, in a next pass of the partially fabricated object 104 under the printheads 114 (not shown), another partial layer of UV curable material 234 is deposited at height H₇, filling the well 732 with UV curable material. The UV curable material 234 flows in the well 732 to fill the area of the well beneath the overhanging portion of the wax material at height H₇ and solidification of the UV curable material 234 is initiated by exposure to UV radiation. Then another partial layer of wax material 230 is deposited at height H₈ and solidifies to form a new well 832 with a new material transition boundary 835 is defined by the wax material at height H₈ and the UV curable material at height H₇. Note that the material transition boundary 835 at height H₈ is formed as a vertical wall. This is yet another type of surface that can be deposited by the printheads 114.

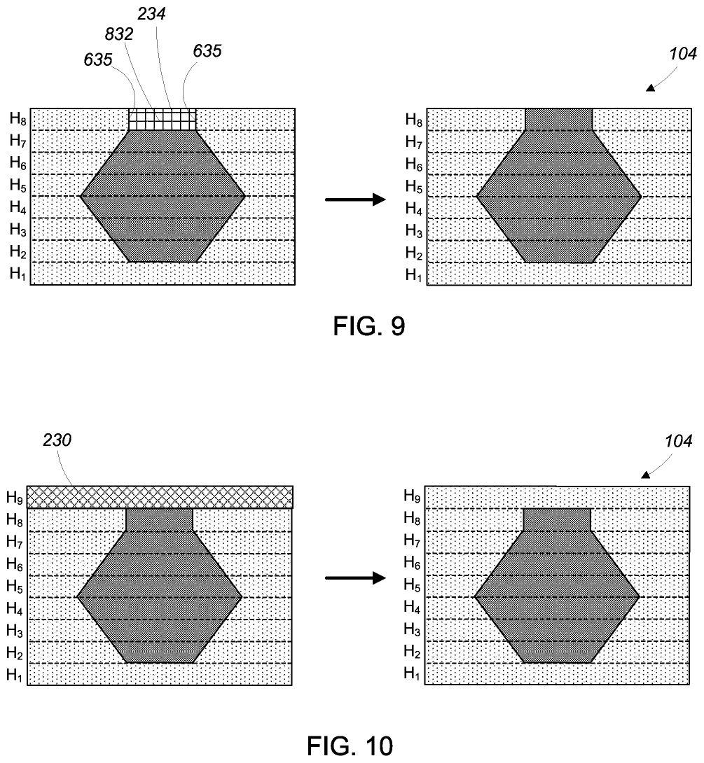

Referring to FIGS. 9 and 10, the final two steps of fabricating the object, the well 832 at height H₈ is filled with the UV curable material 234 and then exposed to UV radiation to initiate curing. A final, full layer of wax material 230 is the deposited at height H₉. In the example of FIGS. 9 and 10, no further wells are required, so the deposition of the wax material no longer leads deposition of the UV curable build material in time or height. That is, in some examples the fabrication process can strategically use the offset printing technique described above only when necessary or beneficial to the fabrication process.

### 3 Example 2

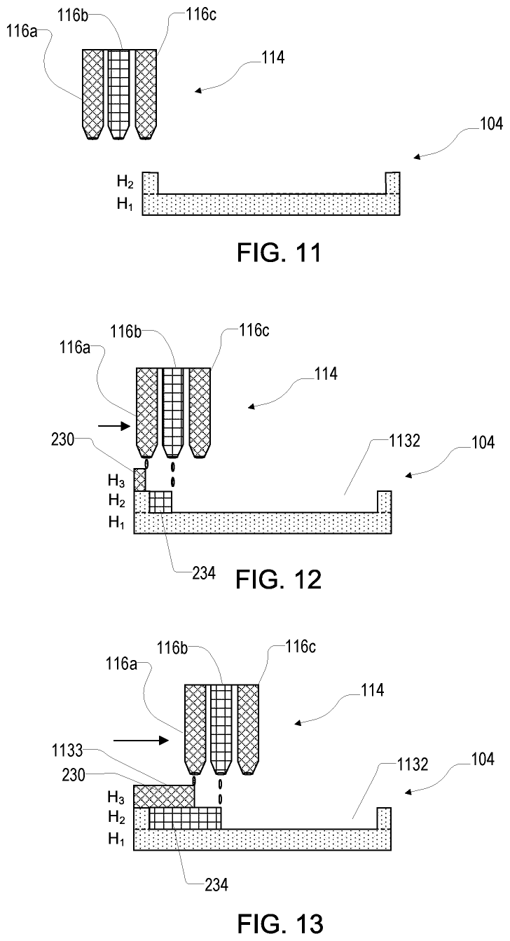

In general, the system 100 is configured for bidirectional operation, where the printheads 114 deposit material as the build platform 118 passes in a first direction (e.g., a left-to-right direction) and as the build platform 118 passes in a second direction (e.g., a right-to-left direction). Referring to FIGS. 11-19, in certain scenarios, fabricating the object 104 requires fabricating “overhangs” where both wax material and UV curable build material are deposited in a single pass, with at least some of the wax material being deposited onto the recently deposited UV curable build material. As is described below, a specific printhead configuration can be used to efficiently fabricate such overhangs during bidirectional operation.

Referring to FIG. 11, a partially fabricated object 104 includes two previously deposited layers of material at heights H₁ and H₂. The printhead 114 includes three jets 116a, 116b, and 116c. A first of the three jets 116a is configured to deposit wax material, a second of the three jets 116b is configured to deposit UV curable build material, and a third of the three jets 116c is also configured to deposit wax material.

Referring to FIG. 12, as the relative position of the printhead 114 to the object 104 on the build platform (not shown) moves in the first direction toward the right-hand side of the page, the second jet 116b deposits UV curable build material 234 in a well 1132 formed in the layer at height H₂. When moving in the first direction, the first jet 116a lags the second jet 116b and simultaneously deposits wax material 230 onto the material at height H₂.

Referring to FIG. 13, as the relative position of the printhead 114 continues to move in the first direction, the second jet 116b continues depositing UV curable build material 234 in the well 1132. The first jet 116a deposits a portion of the wax material 230 at height H₃, where an overhanging part 1133 of the wax material 230 at height H₃ is deposited onto the UV curable build material 234 recently deposited in the well 1132 at height H₂. Such a deposition of an overhanging part of wax material 230 onto a UV curable build material 234 in a single “pass” of the printhead 114 in the first direction is made possible by the offset arrangement of the first jet 116a and the second jet 116b, with the second jet 116b depositing UV curable build material 234 in advance of the first jet 116a depositing wax material 230.

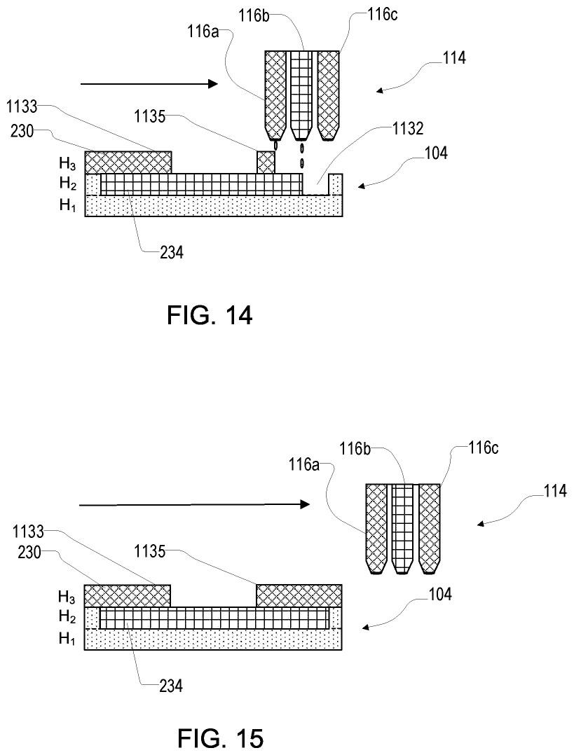

Referring to FIG. 14, the relative position of the printhead 114 continues to move in the first direction and the second jet 116b continues deposition of the UV curable material 234 in the well 1132 at height H₂. The first jet 116a deposits another overhanging part 1135 of the wax material 230 at height H₃ onto the UV curable build material recently deposited in the well 1132 at height H₂. Again, deposition of the overhanging part of wax material 230 onto the UV curable build material 234 in a single “pass” of the printhead 114 in the first direction is made possible by the offset arrangement of the first jet 116a and the second jet 116b, with the second jet 116b depositing UV curable build material 234 in advance of the first jet 116a depositing wax material 230.

In FIG. 15, the first jet 116a deposits additional, non-overhanging wax material 230 to complete the pass.

Referring to FIG. 16, as the relative position of the printhead 114 to the object 104 on the build platform moves in the second direction toward the left-hand side of the page, the second jet 116b deposits UV curable build material 234 in a well 1632 formed in the layer at height H₃. When moving in the first direction, the third jet 116c lags the second jet 116b and simultaneously deposits wax material 230 onto the material at height H₃.

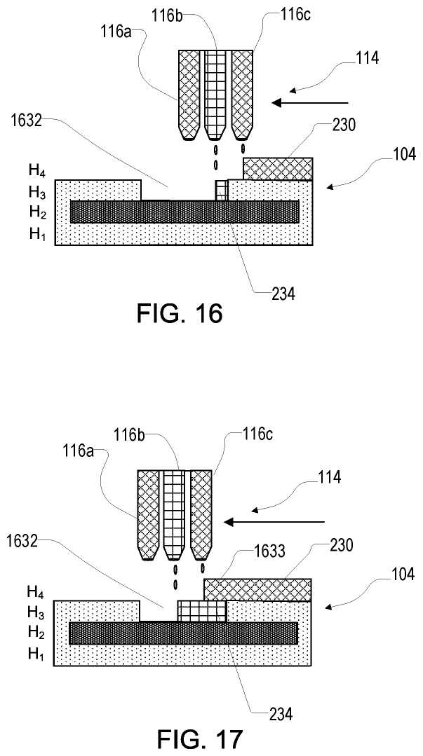

Referring to FIG. 17, the third jet 116c deposits a portion of the wax material 230 at height H₄, where an overhanging part 1633 of the wax material 230 at height H₄ is deposited onto the UV curable build material 234 recently deposited in the well 1632 at height H₃. Such a deposition of an overhanging part of wax material 230 onto a UV curable build material 234 in a single “pass” of the printhead 114 in the second direction is made possible by the offset arrangement of the third jet 116c and the second jet 116b, with the second jet 116b depositing UV curable build material 234 in advance of the third jet 116c depositing wax material 230.

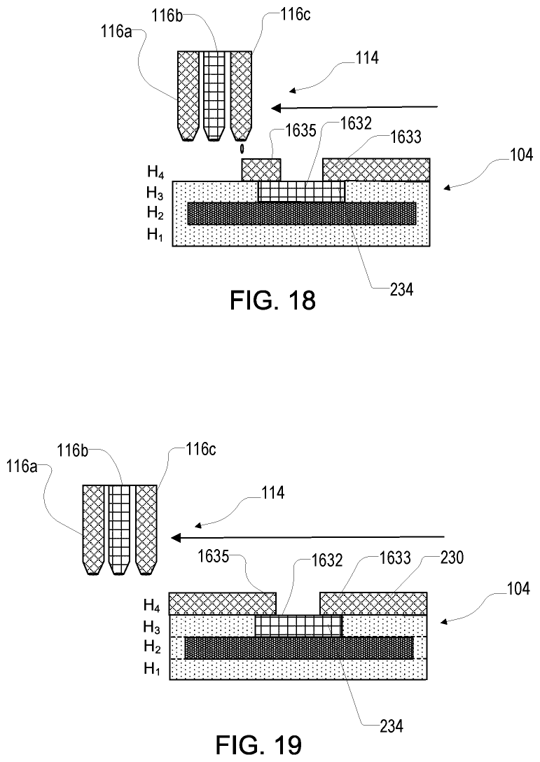

Referring to FIG. 18, the relative position of the printhead 114 continues to move in the second direction after completion of deposition of the UV curable build material 234 and the second jet 116b. The third jet 116c deposits another overhanging part 1635 of the wax material 230 at height H₄ onto the UV curable build material recently deposited in the well 1632 at height H₃. Again, deposition of the overhanging part of wax material 230 onto the UV curable build material 234 in a single “pass” of the printhead 114 in the first direction is made possible by the offset arrangement of the second jet 116b and the third jet 116c, with the second jet 116b depositing UV curable build material 234 in advance of the third jet 116c depositing wax material 230.

In FIG. 19, the second jet 116b completes deposition of the wax material 320 at height H₄.

### 4 Example 3

In the example presented above, planning of the printing passes uses a rule that causes the support material to be deposited one pass before the build material, thereby allowing it to have time to solidify before the next pass in which the build material is deposited at the material boundary point established in the previous printing pass.

More complex rules may be used, for example, by depositing multiple passes of support material before depositing build material at the boundary point, or by selecting the number of passes to lead with one material on the geometry of the part, for example, according to the slope or orientation of the material transition boundary.

More generally, given a multi-material model of an object, more complex planning of the printing passes may be used to reduce mixing and flowing at material boundaries, and may be extended to reduce other forms of distortion of the object during fabrication. One approach to such planning may use a Machine Learning (ML) approach as described in co-pending U.S. application Ser. No. 17/560,455, titled Machine Learning for Additive Manufacturing, which is incorporated herein by reference.

One such Machine Learning approach uses Reinforcement Learning (RL) to learn a policy in which given a partially fabricated object, which in general may have been essentially fabricated with discontinuous boundaries as described above, a learned policy may determine which materials to apply and where in the next jetting pass to yield an optimized accuracy and surface characteristic. For example, the policy may have been determined by simulation of the printing process using a model that characterizes the flowing, mixing, and solidification processes of the material, and optimization of a policy that rewards part accuracy and desired surface character. In addition, physical exportation of the printing process may also provide data for off-line or on-line optimization of the policy. While the learned policy may result in the approach similar to that described in Example 1, more generally, the degree to which one material is deposited ahead of another at a boundary may be influences by a wide variety of factors, such as the specific materials involved and the geometry of the part (e.g., the slope of the material transition). Furthermore, this learned policy may cause structures to be deposited with various types of layering, for example, with support material being tapered and at the boundary “fine tuned” in a thin layer after the bulk of the material has been deposited. Of course, the learned policy for determining the jetting plan for each pass may yield yet other unexpected approaches that optimize the formation of the part. While the examples above describe build material to support material transitions, the same types of approaches may be used for transitions between different build materials.

5 Alternatives

In some examples, more than two materials may be used, with potentially multiple build materials, multiple support materials, or multiple of both. In those embodiments, the deposition of a single pass when using the offset printing technique may comprise the deposition of any number (less than all) of the total number of materials.

In some embodiments, more than one jet might be used. In further embodiments, there may be a distinct jet or jets used for depositing each distinct material. In some embodiments, in a pass, the jets may not deposit a material on every printable coordinate of the surface of the partially fabricated object, and instead may only print on some of the printable coordinates.

In some examples, the offset printing technique does not form wells as in the example described above. For example, all materials deposited may be sufficiently viscous to hold their shape after being deposited, obviating the need to contain the materials in well structures.

In the aspects described above, an order of deposition of materials is specified as build material first at height n and then wax material at height n+1. However, it should be noted that, in some examples, that deposition order can be reversed when physically possible (i.e., the max material in at height n+1 is deposited before or at the same time with the build material at height n).

In some examples, during bidirectional operation, build material is deposited when the relative motion of the printhead is in a first direction and support material is deposited when the relative motion of the printhead is in the second direction.

In the description above, the object is fabricated using a wax material as support material. However, more generally the support material is a thermal phase change material including waxes and plastics with low melting temperatures. Wax and plastic materials are particularly useful to establish the boundaries of the “wells” described above because they quickly set without flowing/spreading.

Similarly, the build material isn't necessarily a UV curable resin but instead could be, for example, a thermoset material. In general, materials that can flow are best for use as build material because they flow to fill the wells in which they are deposited.

In some examples, the wax material is deposited one layer prior to the build material. However, in other examples, the deposition of wax material can lead or possibly even lag deposition of the build material by two or more layers. In some examples, rules can be used to determine how many layers deposition of the wax material leads deposition of the build material. In other examples, a physical model (based on parameters such as material flow, setting time, etc.) is used to determine how many layers the deposition of wax material can feasibly lead the deposition of build material.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. A method for additive fabrication of an object on a build platform, the method comprising:
depositing material onto a partial fabrication of the object in a plurality of passes of a printhead over the partial fabrication of the object, the depositing including repeatedly
determining surface data for the partial fabrication of the object including sensing a surface of the partial fabrication of the object using a non-contact sensor;
depositing, based on the surface data, material onto the partial fabrication of the object in a pass of the printhead over the partial fabrication, the depositing including,
depositing a first material onto the partial fabrication of the object at a first height relative to the build platform, and
depositing a second material onto the partial fabrication of the object at a second height relative to the build platform, the second height being less than the first height, the depositing of the second material including forming at least one material transition region between the second material at the second height and first material at the second height deposited in a previous pass.

2. The method of claim 1 wherein the first material is a phase change material configured to be deposited as a liquid and to solidify as it cools.

3. The method of claim 2 wherein the first material is a wax.

4. The method of claim 2 wherein the first material is a thermoplastic.

5. The method of claim 1 wherein the second material is a curable resin.

6. The method of claim 5 wherein the second material is deposited as a liquid and is curable by exposure to ultraviolet radiation.

7. The method of claim 1 wherein the first material has a first rate of solidification, the second material has a second rate of solidification, and the first rate of solidification is relatively faster than the second rate of solidification.

8. The method of claim 1 wherein the first material at the second height deposited in a previous pass is substantially solid at the material transition region when the second material is deposited at the second height.

9. The method of claim 1 wherein the non-contact sensor includes a laser profilometer.

10. The method of claim 1 wherein the first material is dispensed from a first set of one or more nozzles of the printhead and the second material is dispensed from a second set of one or more nozzles of the printhead.

11. The method of claim 10 wherein the printhead is configured for bidirectional deposition of material.

12. The method of claim 11 wherein the printhead includes a third set of one or more nozzles for dispensing the first material, the second set of one or more nozzles being disposed between the first set of one or more nozzles and the third set of one or more nozzles.

13. The method of claim 1 wherein a surface discontinuity is formed at the material transition region.

14. The method of claim 1 wherein a layer of material is deposited onto at least part of the surface of the partial fabrication of the object during each pass.

15. The method of claim 1 wherein depositing material onto the partial fabrication of the object based on the surface data includes adjusting an amount of material deposited onto the surface as the printhead moves past the surface based on the surface data.

16. The method of claim 1 wherein depositing of the second material includes forming two material transition regions between the second material at the second height and first material at the second height deposited in a previous pass.

17. The method of claim 16 wherein a well is formed between the two material transition regions at the second height and the second material flows to fill the well.

18. The method of claim 1 wherein at least one of the one or more material transition regions is a tapered surface.

19. An apparatus for additive fabrication of an object on a build platform, the method comprising:
a non-contact sensor for determining surface data of a partial fabrication of the object;
a printhead configured to deposit material;
a controller configured to control the printhead, the build platform, and the non-contact sensor to deposit material onto the partial fabrication of the object in a plurality of passes of the printhead over the partial fabrication of the object including repeatedly
determining surface data for the partial fabrication of the object including sensing a surface of the partial fabrication of the object using a non-contact sensor;
depositing, based on the surface data, material onto the partial fabrication of the object in a pass of the printhead over the partial fabrication, the depositing including,
depositing a first material onto the partial fabrication of the object at a first height relative to the build platform, and
depositing a second material onto the partial fabrication of the object at a second height relative to the build platform, the second height being less than the first height, the depositing of the second material including forming at least one material transition region between the second material at the second height and first material at the second height deposited in a previous pass.

20. A non-transitory computer readable medium including software and instructions for additive fabrication of an object on a build platform, the software including instructions for causing an additive fabrication system to perform steps of a method comprising:
depositing material onto a partial fabrication of the object in a plurality of passes of a printhead over the partial fabrication of the object, the depositing including repeatedly
determining surface data for the partial fabrication of the object including sensing a surface of the partial fabrication of the object using a non-contact sensor;
depositing, based on the surface data, material onto the partial fabrication of the object in a pass of the printhead over the partial fabrication, the depositing including,
depositing a first material onto the partial fabrication of the object at a first height relative to the build platform, and
depositing a second material onto the partial fabrication of the object at a second height relative to the build platform, the second height being less than the first height, the depositing of the second material including forming at least one material transition region between the second material at the second height and first material at the second height deposited in a previous pass.
